(19) United States
(12) Patent Application Publication
(10) Pub. No.: US 2005/0107044 A1
(43) Pub. Date: May 19, 2005

(54) Active antenna with amplifier

(75) Inventor: Bum-youl Bae, Daejeon (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/972,473

(22) Filed: Oct. 26, 2004

(30) Foreign Application Priority Data
Nov. 19, 2003 (KR) 2003-0082230

(51) Int. Cl. H04B 1/44

(52) U.S. Cl. 455/78; 455/73

(57) ABSTRACT

An active antenna, the electrical length of which can be varied with the use of an inductor coil and which has an amplification circuit, is provided. The active antenna comprises a passive antenna module, which receives a signal within a predetermined frequency band and adjusts an electrical length thereof; and an amplification circuit, which amplifies a signal output from the passive antenna module at an antenna port and transmits the amplified signal to a digital broadcast receiver. The active antenna obtains a high signal-to-noise ratio by amplifying the signal at the antenna port in a digital broadcast receiver, which receives data-in-national television system committee (dNTSC).

This application claims the benefit under 35 USC 119(a) of Korean Patent Application No. 10-2003-0082230 filed on Nov. 19, 2003 in the Korean Intellectual Property Office, the entire contents of which are incorporated herein by reference.

### BACKGROUND OF THE INVENTION

1. Field of the Invention

The present invention relates to an antenna for receiving wireless signals, and more particularly, to an active antenna with an inherent amplifier, the electrical length of which can be adjusted by using inductor coils.

2. Description of the Related Art

Currently in North America, the National Television System Committee (NTSC) broadcast system has been adopted for analog TV broadcasting, and the Advanced Television System Committee (ATSC) broadcast system has been adopted for digital TV broadcasting. A data-in-NTSC (dNTSC) video broadcast, in which digital signals are interleaved into an NTSC band and broadcasted, is carried out in VHF-H bands. Outdoor antenna or indoor antenna models have been used for VHF-H band antennas for receiving dNTSC video broadcasts. Indoor antennas may be more convenient than outdoor antennas because it is easier to connect an indoor antenna to a digital set-top box (STB), which is necessary for receiving digital broadcasts, than to connect an outdoor antenna to a digital STB.

FIG. 1 illustrates a frequency spectrum based on the dNTSC system in a VHF-H band. An analog broadcast signal 100 and a digital broadcast signal 200 are carried on a carrier after being modulated using a double side band (DSB) modulation method. In the NTSC broadcast system, the analog broadcast signal 100, the frequency of which ranges between f_{cl} and f_{ch}, is carried on a carrier and then broadcast. In the dNTSC broadcast system, the digital broadcast signal 200, i.e., a dNTSC data signal, which is beyond the frequency band of the analog broadcast signal 100, is additionally carried on the carrier and then broadcast together with the analog broadcast signal 100.

FIG. 2 is a table showing frequencies of various signals shown in FIG. 1, which are indicated in different VHF channels 7 through 13. Referring to FIG. 2, a carrier wave has a frequency range from about 170 MHz to 220 MHz. Analog broadcast signals in VHF channels 7 through 13 all have a frequency bandwidth of about 0.1 MHz. dNTSC data in VHF channels 7 through 13 all have a frequency bandwidth of about 0.76 MHz.

An indoor antenna is not suitable for receiving VHF-H band signals which include digital broadcast signals because of many spatial restrictions. In addition, due to these spatial restrictions, it is very difficult to set the size of an antenna according to the desired frequency band and to design the antenna as a dipole antenna, in particular. The length of a dipole antenna amounts to half of the frequency of the dipole antenna. For example, a dipole antenna should have a length of 0.88 m to cover a frequency of 170 MHz (300/170/2=0.88 m). However, an antenna of such size is unsuitable and inconvenient to use indoors. Thus, it is necessary to design an antenna which has the desired electrical length but also occupies a smaller space.

Signals within a VHF-H band are more likely to be corrupted by noise than signals in a higher frequency band. Thus, it is necessary to amplify the signals in the VHF-H band in order to obtain a higher signal-to-noise ratio (SNR). Since signals amplified at the antenna port of a digital broadcast receiver are more likely to have a higher signal-to-noise ratio than the signals amplified in other parts of the digital broadcast receiver, it is necessary to develop a digital broadcast receiver which actively amplifies signals using an antenna to obtain a higher SNR.

### SUMMARY OF THE INVENTION

The present invention provides a VHF-H band antenna of which the electrical length can be increased with the use of serial inductors.

The present invention also provides a digital receiving apparatus, which can overcome the limitations of a conventional passive antenna and can obtain a high signal-to-noise ratio (SNR) by amplifying signals at an end of an antenna.

In accordance with an exemplary embodiment of the present invention, there is provided an active antenna comprising a passive antenna module, which receives a signal within a predetermined frequency band that is input spatially by adjusting an electrical length thereof, and an amplification circuit, which amplifies a signal output from the passive antenna module at an antenna port and transmits the amplified signal to a digital broadcast receiver.

The active antenna further comprises a bias-stabilizing module, which stabilizes a bias voltage applied from the digital broadcast receiver by removing components other than the bias component from the bias voltage.

The active antenna can also comprise a bias-blocking module, which blocks the bias current generated by the bias voltage applied from the digital broadcast receiver and allows the signal output from the signal-amplifying module pass through the same, and a signal-blocking module, which prevents the signal from being transmitted along a path of the bias current passing through the bias-stabilizing module.

The active antenna further comprises an electrostatic discharge (ESD) protecting module, which protects the bias voltage applied from the digital broadcast receiver against deleterious electrostatic discharges so that the bias voltage can be maintained at a predetermined level or lower.

The digital broadcast receiver preferably receives data-in-national television system committee (dNTSC) data transmitted in a VHF-H band.

The passive antenna module can comprise an inductor coil, which varies the electrical length of the passive antenna module to receive a predetermined signal, a first capacitor, which matches impedance thereof with that of the inductor coil for a predetermined frequency band, and a second capacitor, which serves as a tuning point for the predetermined frequency band.

The predetermined frequency band is preferably a VHF-H band.

The signal-amplifying module can comprise a transistor, which amplifies a signal input to a base thereof from the passive antennal module by a predetermined gain and outputs the amplified signal to a collector thereof, and at least one resistor, which controls the bias voltage of the transistor.

Also, the active antenna can further comprise a capacitor, which matches impedances of the signal output from the passive antenna module and input to the signal amplifying module.

The bias-stabilizing module can comprise a voltage regulator, which attenuates the noise component included in the bias voltage applied from the digital broadcast receiver, and at least one capacitor, which stabilizes the bias voltage applied thereto.

The bias-blocking module may serve as a capacitor, which couples signals output from the signal-amplifying module.

The signal-blocking module preferably includes two inductors.

The electrostatic discharge (ESD) protecting module is preferably a Zener diode.

### BRIEF DESCRIPTION OF THE DRAWINGS

The above features, as well as other features and advantages of the present invention, will become more apparent through a detailed description of the exemplary embodiments thereof, with reference to the attached drawings in which:

FIG. 1 illustrates the frequency spectrum based on the dNTSC broadcast system in a VHF-H band;

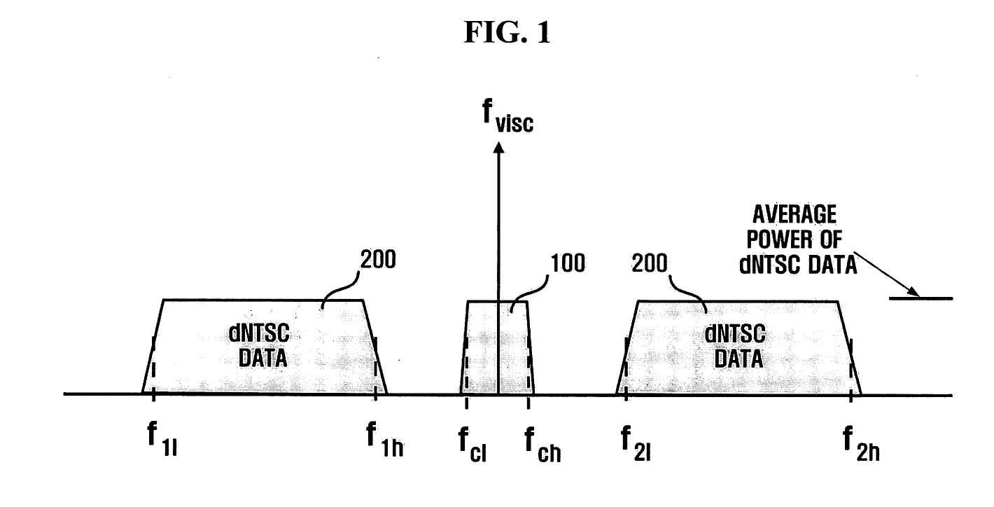

FIG. 2 is a table showing frequencies of various signals shown in FIG. 1;

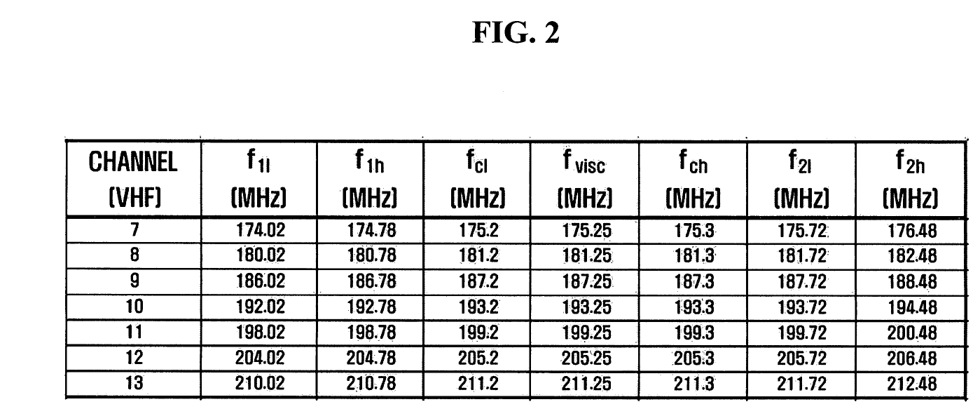

FIG. 3 is a block diagram of an active antenna according to an exemplary embodiment of the present invention; and

FIG. 4 is a schematic circuit diagram of an active antenna according to an exemplary embodiment of the present invention.

### DETAILED DESCRIPTION OF THE PREFERRED EMBODIMENTS

The present invention will now be described more fully with reference to the accompanying drawings, in which preferred embodiments of the invention are shown. This invention may, however, be embodied in many different forms and should not be construed as being limited to the embodiments set forth herein. In the drawings, the same reference numerals represent the same elements.

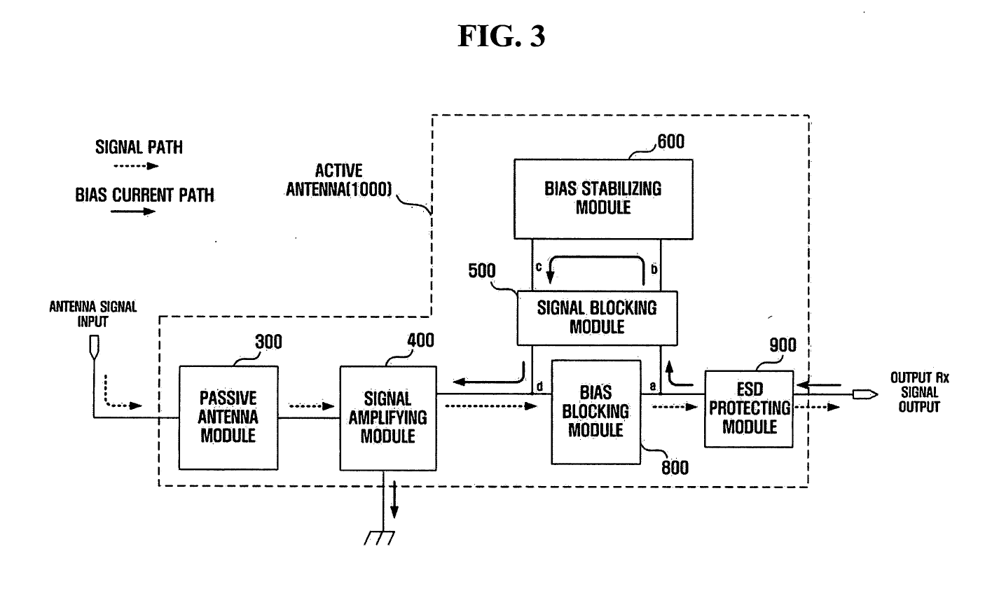

FIG. 3 is a block diagram of an active antenna according to an exemplary embodiment of the present invention. Referring to FIG. 3, a bias current supplied from a receiver (Rx) signal output unit, i.e., a digital broadcast receiver (such as a set-top box), is input to the active antenna 1000 and passes through an electrostatic discharge (ESD) protecting module 900. The ESD protecting module 900 protects the input voltage against electrostatic discharges so that the input voltage can be maintained at a predetermined level or lower. After passing through the ESD protecting module 900, the bias current passes through a signal-blocking module 500. The signal-blocking module 500 prevents the signal output from the signal amplifying module 400 from being transmitted along a bias line, i.e., a path of the bias current passing through a bias-stabilizing module 600, by impedance mismatching. A bias-blocking module 800 blocks the bias current while allowing AC current pass through the same. Therefore, the bias current output from the ESD protecting module 900 cannot flow in a direction from a portion of a path indicated by “a” to a portion of a path indicated by “d”. Instead, the bias current output from the ESD protecting module 900 flows to the signal-blocking module 500 in a direction from “a” to “b,” as shown in FIG. 3.

A bias current passing through the signal-blocking module 500 is input to the bias-stabilizing module 600. The bias-stabilizing module 600 stabilizes the bias current input thereto by removing undesired components, such as ripples or noise, from the corresponding bias current. A bias current output from the bias-stabilizing module 600 is input to the signal-amplifying module 400 via the signal-blocking module 500 to then be grounded.

An input signal path will now be described with reference to FIG. 3. A signal is input to the active antenna 1000 via a passive antenna module 300, which is a conventional passive antenna. The signal passing through the passive antenna module 300 is input to the signal-amplifying module 400. The signal-amplifying module 400 amplifies the signal input thereto so that the amplified signal becomes compatible with the set-top box. The amplified signal passes through the bias-blocking module 800. Since the amplified signal is AC current, it can pass through the bias-blocking module 800, which blocks the bias current and allows the AC current to pass through. The amplified signal passing through the bias-blocking module 800 is not transmitted along a path from “d” to “c”, but is transmitted only to the bias-blocking module 800 because the signal-blocking module 500 prevents the signal from being transmitted along the bias line by impedance mismatching. The signal passing through the bias-blocking module 800 cannot be transmitted in a direction from “b” to “a”, due to the signal-blocking module 500. Instead, the signal passing through the bias-blocking module 800 is input to the ESD protecting module 900. A signal passing through the ESD protecting module 900 is finally input to the set-top box as the Rx signal output.

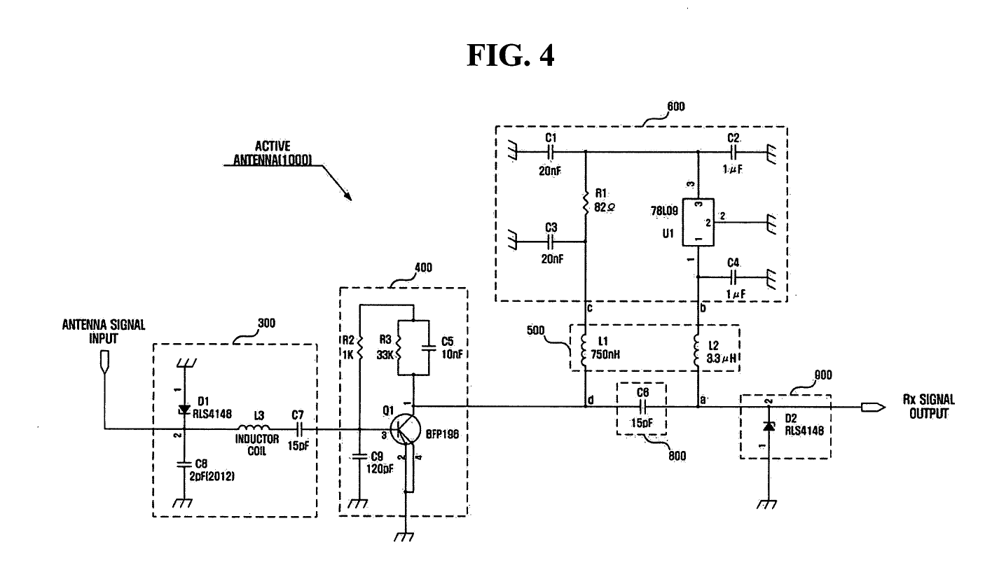

FIG. 4 is a schematic circuit diagram of the active antenna 1000 according to an exemplary embodiment of the present invention.

Referring to FIG. 4, the passive antenna module 300 is of a passive type, that is, the passive antenna module 300 is composed of substantially passive devices, and comprises a variable inductor coil L3, which can vary the electrical length of the passive antenna module 300 in a range between 12 cm and 22 cm. Therefore, the passive antenna module 300 can cover a frequency band from 170 MHz to 220 MHz, i.e., a VHF-H band. In order to increase the SNR in the VHF-H frequency band by impedance matching, a coupling capacitor C7 is coupled to the variable inductor coil L3. The passive antenna module 300 further includes a capacitor C8, which serves as a tuning point, and a Zener diode D1, which maintains the magnitude of an AC signal input to the active antenna 100 at a predetermined level or lower. A commercially available diode model RLS4148 is preferably used as the Zener diode D1.

A signal is spatially input to the passive antenna module 300 and then transmitted to the signal-amplifying module 400 via the coupling capacitor C7. The signal-amplifying module 400 includes a transistor Q1, which amplifies the signal input thereto. A voltage of 8 V is applied from the set-top box to the collector in the transistor Q1. A resistor R3 in parallel with a capacitor C5, and a resistor R2 are connected in series between the collector and the base of the transistor Q1. The resistors R2 and R3 control the bias voltage of the transistor Q1. A base voltage is determined by the resistor R2, the resistor R3, the capacitor C5, and properties of the transistor Q1. In the illustrative embodiment, a voltage of 0.7 V is applied to the base of the transistor Q1 and serves as a threshold voltage. A capacitor C9 matches impedances of the signal output from the passive antenna module 300 to then be input to the signal amplifying module 400.

A transistor BFP196LAN, manufactured by SimensAG, can be used as the transistor Q1. It is preferable to amplify the signal in the signal amplifying-module 400 located closer to the passive antenna module 300 rather than in the set-top box, because the closer the signal is to the input port of the active antenna 1000, the less the signal is distorted. Also, a signal with less distortion is more likely to have a high SNR after being amplified. The transistor Q1 is designed such that its gain becomes 12 dB in the VHF-H band. In this case, the current at the collector of the transistor Q1 is 50 mA.

With reference to FIG. 4, the signal input to the base of the transistor Q1 is amplified by a predetermined gain and then output from the collector of the transistor Q1. Since the signal output from the collector of the transistor Q1 is an AC signal, it can pass through the capacitor C6. The capacitor C6 serves as a coupling capacitor, with regard to output signals from the transistor Q1. The signal output from the collector of the transistor Q1 is controlled using an inductor L1 to perform inductance mismatching so that it cannot be transmitted in a direction from “d” to “c”. A signal passing through the capacitor C6 is controlled by an inductor L2 to perform inductance mismatching so that it cannot be transmitted in a direction “a” to “b”. Therefore, the signal passing through the capacitor C6 is input to the set-top box as the Rx signal output.

Referring to FIG. 4, a bias voltage of 12 V is applied to the Rx signal output port from the set-top box. The bias voltage applied to the Rx signal output port protects the input voltage against sudden electrostatic discharges caused by the Zener diode D2 so that the input voltage can be maintained at the predetermined level or lower. Like in the Zener diode D1, diode model No. RLS4148 can be used as the Zener diode D2. Since the bias current passing through the Zener diode D2 is DC current, it cannot pass through the capacitor C6 and flow toward the inductor L2. A bias current passing through the inductor L2 is input to a voltage regulator U1. The voltage regulator U1 can be realized as voltage regulator model No. 78L09. The voltage regulator U1 attenuates the noise component included in the power supply voltage applied from the Rx signal output port, i.e., the set-top box. More specifically, the voltage regulator U1 stabilizes the bias voltage by removing components other than the bias component from the bias voltage. A bias voltage of 12 V is applied to an input port 1 of the voltage regulator U1, and a bias voltage of 9 V is applied to an output port 3 of the voltage regulator U1. The bias voltage applied to the output port 3 of the voltage regulator U1 is dropped to 8 V while passing through the resistor R1, so that a bias voltage of 8 V is supplied to the collector of the transistor q1. The bias-stabilizing module 600 comprises the voltage regulator U1 and four capacitors C1, C2, C3 and C4. Each of the four capacitors C1 through C4 stabilizes a bias voltage input thereto.

Thus, a bias voltage of 8 V is applied to the collector of the transistor Q1, and a voltage of 0.7 V is applied to the base of the transistor Q1.

Therefore, the active antenna according to the present invention is better able than a conventional passive antenna to reduce the influence of the length of an antenna on the frequency band that the antenna can cover. Numerous test results show that the present invention can attenuate the variation of frequency with respect to the length of an antenna by variably setting the electrical length of the passive antenna module 300. Therefore, the active antenna according to the present invention, can serve as a broadband antenna.

According to the present invention, an indoor antenna responsible for the VHF-H band can be used in a very small space.

In addition, it is possible to obtain a high signal-to-noise ratio by amplifying dNTSC data at the antenna port in a digital receiver.

Moreover, the active antenna according to the present invention can reduce the influence of the length of the antenna on the frequency band that the antenna can cover more than a conventional passive antenna. Therefore, the active antenna according to the present invention can serve as a broadband antenna.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims. Therefore, the described embodiments are to be considered in all respects only as illustrative and not restrictive to the scope of the invention.

1. An active antenna comprising:
a passive antenna module, which receives a signal within a predetermined frequency band and adjust an electrical length thereof; and
a signal-amplifying module, which amplifies a signal output from the passive antenna module at an antenna port and transmits the amplified signal to a digital broadcast receiver.

2. The active antenna of claim 1, further comprising a bias-stabilizing module, which stabilizes a bias voltage supplied from the digital broadcast receiver by removing components other than the bias component from the bias voltage.

3. The active antenna of claim 2, further comprising:
a bias-blocking module, which blocks the bias current generated by the bias voltage supplied from the digital broadcast receiver and allows the signal output from the signal-amplifying module pass through the same; and
a signal-blocking module, which prevents the signal from being transmitted along a path of the bias current passing through the bias-stabilizing module.

4. The active antenna of claim 3, further comprising an electrostatic discharge (ESD) protecting module, which protects the bias voltage supplied from the digital broadcast receiver against electrostatic discharges so that the bias voltage can be maintained at a predetermined level or lower.

5. The active antenna of claim 1, wherein the digital broadcast receiver receives data-in-National Television System Committee (dNTSC) data transmitted in a VHF-H band.

6. The active antenna of claim 1, wherein the passive antenna module comprises:
an inductor coil, which varies the electrical length of the passive antenna module to receive a predetermined signal;
a first capacitor, which matches impedance thereof with that of the inductor coil for a predetermined frequency band; and
a second capacitor, which serves as a tuning point for the predetermined frequency band.

7. The active antenna of claim 6, wherein the predetermined frequency band is a VHF-H band.

8. The active antenna of claim 1, wherein the signal-amplifying module comprises:
a transistor, which amplifies a signal input to a base thereof from the passive antennal module by a predetermined gain and outputs the amplified signal to a collector thereof; and
at least one resistor, which controls the bias voltage of the transistor.

9. The active antenna of claim 8, further comprising a capacitor for matching input impedances of signals that are output from the passive antenna module and input to the signal-amplifying module.

10. The active antenna of claim 2, wherein the bias-stabilizing module comprises:
a voltage regulator, which attenuates the noise component included in the bias voltage supplied from the digital broadcast receiver; and
at least one capacitor, which stabilizes the bias voltage applied thereto.

11. The active antenna of claim 3, wherein the bias-blocking module serves as a capacitor, which couples signals output from the signal-amplifying module.

12. The active antenna of claim 3, wherein the signal-blocking module comprises two inductors.

13. The active antenna of claim 4, wherein the electrostatic discharge (ESD) protecting module is a Zener diode.

14. A method of operating an active antenna comprising the steps of:
receiving a signal within a predetermined frequency band and adjusting an electrical length thereof via a passive antenna; and
amplifying the signal and transmitting the amplified signal to a digital broadcast receiver, the signal being amplified more proximally to the passive antenna than to the digital broadcast receiver.

15. A method as claimed in claim 14, further comprising the step of:
stabilizing a bias voltage supplied from the digital broadcast receiver by removing components other than the bias component from the bias voltage.

16. A method as claimed in claim 15, further comprising the steps of:
blocking the bias current generated by the bias voltage supplied from the digital broadcast receiver while passing the amplified signal; and
preventing the signal from being transmitted along the path of the bias current.

17. A method as claimed in claim 16, further comprising the step of protecting the bias voltage supplied from the digital broadcast receiver against electrostatic discharges so that the bias voltage can be maintained at a predetermined level or lower.

18. A method as claimed in claim 14, wherein the receiving step further comprises the steps of:
varying the electrical length of a passive antenna to receive a predetermined signal; and
matching the impedance of a capacitor with that of an inductor coil for a predetermined frequency band.

19. A method as claimed in claim 17, wherein the predetermined frequency band is a VHF-H band.

20. A method as claimed in claim 15, wherein the stabilizing step comprises the step of:
attenuating the noise component included in the bias voltage supplied from the digital broadcast receiver.
